(19) United States
(12) Patent Application Publication
(10) Pub. No.: US 2021/0333930 A1
(43) Pub. Date: Oct. 28, 2021

(54) TOUCH SUBSTRATE, MANUFACTURING METHOD THEREOF, AND TOUCH DISPLAY DEVICE

(71) Applicants: CHENGDU BOE OPTOELECTRONICS TECHNOLOGY CO., LTD., Chengdu, Sichuan (CN); BOE TECHNOLOGY GROUP CO., LTD., Beijing (CN)

(72) Inventor: Biyu ZHAO, Beijing (CN)

(21) Appl. No.: 16/319,732

(22) PCT Filed: May 11, 2018
(86) PCT No.: PCT/CN2018/086419

§ 371 Date: Jan. 22, 2019

(30) Foreign Application Priority Data
Aug. 2, 2017 (CN) 201710652716.3

(51) Int. Cl. G06F 3/044

(52) U.S. Cl. CPC G06F 3/0443; G06F 3/0448; G06F 2203/04111; G06F 2203/04102; G06F 2203/04103

(57) ABSTRACT

A touch substrate, a manufacturing method thereof and a touch device are provided. The touch substrate includes a base substrate and a touch sensor disposed on the base substrate; the touch sensor includes a plurality of hollow parts arranged radially.

The present application claims the benefits of Chinese patent application No. 201710652716.3, which was filed with the SIPO on Aug. 2, 2017 and is fully incorporated herein by reference as part of the embodiments of this application.

### TECHNICAL FIELD

At least one embodiment of the present disclosure relates to a touch substrate, a manufacturing method thereof and a touch display device.

### BACKGROUND

In recent years, flexible screen display module has been gradually appeared in the market of display screens and has increasingly become the development direction of display screens. In manufacturing the flexible screen display module, one of the key technologies is the production and design of touch substrates or touch screens.

### SUMMARY

At least one embodiment of the present disclosure relates to a touch substrate, a manufacturing method thereof and a touch display device, which can avoid a poor touch performance resulted by a breakage of a pattern of touch sensor caused by a flexural fold generated from curving.

At least one embodiment of the present disclosure provides a touch substrate, including a base substrate and a touch sensor on the base substrate. The touch sensor includes a plurality of hollow parts arranged radially.

According to the touch substrate provided by an embodiment of the present disclosure, the plurality of hollow parts is located at a position close to an edge of the base substrate.

According to the touch substrate provided by an embodiment of the present disclosure, the base substrate includes at least one corner, and the at least one corner is provided with the plurality of hollow parts arranged radially.

According to the touch substrate provided by an embodiment of the present disclosure, in a direction from a position close to an edge of the base substrate to a position far away from the edge of the base substrate, adjacent two of the plurality of hollow parts are gradually converged.

According to the touch substrate provided by an embodiment of the present disclosure, each of the plurality of the hollow parts has a shape same as a shape of a side edge of the touch sensor.

According to the touch substrate provided by an embodiment of the present disclosure, the shape of the side edge of the touch sensor includes a fold line shape.

According to the touch substrate provided by an embodiment of the present disclosure, the hollow parts have a same shape.

According to the touch substrate provided by an embodiment of the present disclosure, each of the hollow parts includes a fold line shape, a curved line shape or a straight line shape.

According to the touch substrate provided by an embodiment of the present disclosure, a portion of the touch sensor located between adjacent ones of the plurality of hollow parts is a sub-sensor part; sub-sensor parts are electrically connected with each other; and in a direction from a position close to an edge of the base substrate to a position far away from the edge of the base substrate, two side edges of the sub-sensor part are gradually converged.

According to the touch substrate provided by an embodiment of the present disclosure, each of the plurality of hollow parts includes a plurality of sub-hollow parts, a connection part is provided between adjacent ones of the plurality of sub-hollow parts, and adjacent ones of the plurality of sub-sensor parts are electrically connected through the connection part.

According to the touch substrate provided by an embodiment of the present disclosure, the plurality of sub-hollow parts are spaced apart from each other and are extending in a same direction.

According to the touch substrate provided by an embodiment of the present disclosure, the touch sensor and the plurality of hollow parts are formed from a same touch film layer; the touch sensor is a reserved portion of the touch film layer; and the plurality of hollow parts is a removed portion of the touch film layer.

According to the touch substrate provided by an embodiment of the present disclosure, the plurality of hollow parts arranged radially has an axisymmetric structure.

According to the touch substrate provided by an embodiment of the present disclosure, the touch sensor includes a first touch sensor and a second touch sensor; a plurality of hollow parts arranged radially in the first touch sensor and a plurality of hollow parts arranged radially in the second touch sensor have an axisymmetric structure.

At least one embodiment of the present disclosure provides a manufacturing method of a touch substrate, including: forming a touch sensor on a base substrate. The touch sensor includes a plurality of hollow parts arranged radially.

According to the manufacturing method of the touch substrate provided by an embodiment of the present disclosure, the plurality of hollow parts is located at a position close to an edge of the base substrate.

According to the manufacturing method of the touch substrate provided by an embodiment of the present disclosure, the touch sensor and the plurality of hollow parts are formed from a same touch film layer by a same patterning process; the touch sensor is a reserved portion of the touch film layer; and the plurality of hollow parts is a removed portion of the touch film layer.

At least one embodiment of the present disclosure provides a touch display device, including the touch substrate provided by any of the embodiments of the present disclosure.

### BRIEF DESCRIPTION OF THE DRAWINGS

Hereinafter, the drawings accompanying embodiments of the present disclosure are simply introduced in order to more clearly explain technical solution(s) of the embodiments of the present disclosure. Obviously, the described drawings below are merely related to some of the embodiments of the present disclosure without constituting any limitation thereto.

FIG. 1A is a plan view of a touch substrate;

FIG. 1B is a plan view of a position A in FIG. 1A;

FIG. 1C is an enlarged view of a position B in FIG. 1B;

FIG. 1D is a section view taken along CD direction in FIG. 1C and FIG. 2B;

FIG. 1E is a section view taken along EF direction in FIG. 1C and FIG. 2B;

FIG. 2A is a plan view of a touch substrate (only illustrating a corner position) provided by an embodiment of the present disclosure;

FIG. 2B is an enlarged view of a position G in FIG. 2A;

FIG. 2C is a section view taken along JK direction in FIG. 2B;

FIG. 3 is a plan view (only illustrating a corner position) of a touch substrate provided by another embodiment of the present disclosure;

FIG. 4 is a plan view (only illustrating a corner position) of a touch substrate provided by yet another embodiment of the present disclosure;

FIG. 5 is a plan view (only illustrating a corner position) of a touch substrate provided by further another embodiment of the present disclosure; and

FIG. 6 is a section view of a touch display device provided by another embodiment of the present disclosure.

### DETAILED DESCRIPTION

In order to make objects, technical details and advantages of the embodiments of the invention apparent, technical solutions according to the embodiments of the present invention will be described clearly and completely as below in conjunction with the accompanying drawings of embodiments of the present invention. It is to be understood that the described embodiments are only a part of but not all of exemplary embodiments of the present invention. Based on the described embodiments of the present invention, various other embodiments can be obtained by those of ordinary skill in the art without creative labor and those embodiments shall fall into the protection scope of the present invention.

Unless otherwise defined, all the technical and scientific terms used herein have the same meanings as commonly understood by one of ordinary skill in the art to which the present invention belongs. The terms, such as “first,” “second,” or the like, which are used in the description and the claims of the present application, are not intended to indicate any sequence, amount or importance, but for distinguishing various components. Also, the terms, such as “comprise/comprising,” “include/including,” or the like are intended to specify that the elements or the objects stated before these terms encompass the elements or the objects and equivalents thereof listed after these terms, but not preclude other elements or objects. The terms, such as “connect/connecting/connected,” “couple/coupling/coupled” or the like, are not intended to define a physical connection or mechanical connection, but may include an electrical connection/coupling, directly or indirectly. The terms, “on,” “under,” “left,” “right,” or the like are only used to indicate relative position relationship, and when the position of the object which is described is changed, the relative position relationship may be changed accordingly.

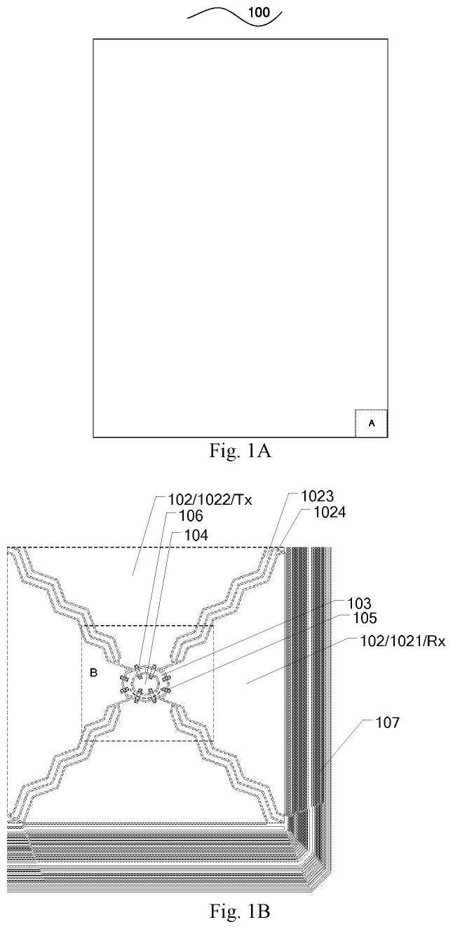

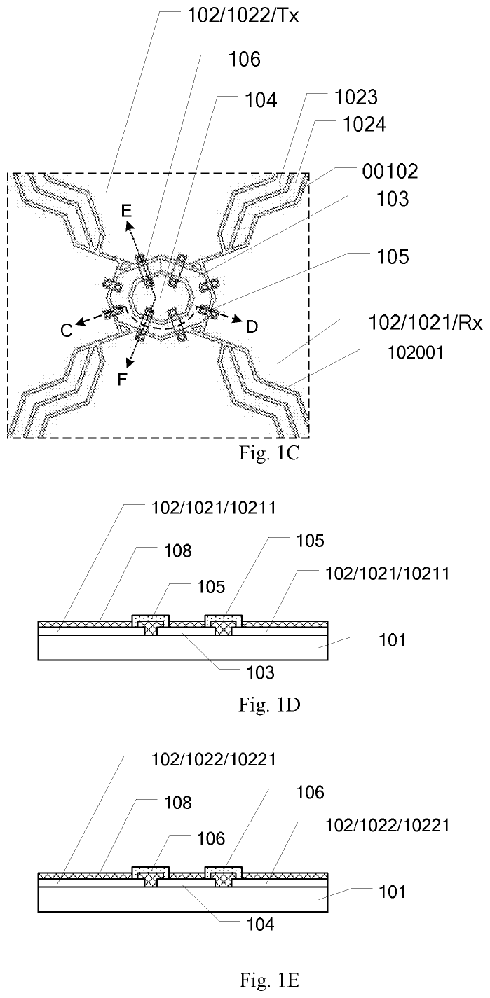

FIG. 1A illustrates a plan view of a touch substrate. The touch flexible display screen is liable to generate a flexural fold during curving and causes a pattern of touch sensor to be broken, which is likely to result in a poor touch performance. For example, for a touch flexible display screen in a form of cover glass having four sides curved, the pattern of touch sensor at a corner position thereof is liable to be broken during curving and results in a poor touch performance. Currently, because a base substrate of a flexible touch substrate mostly is made of a flexible material such as cycloolefin polymer (COP), polyimide (PI), polyethylene terephthalate (PET) or the like, it has a thickness about 45 μm, without limited thereto. When curving the four sides, an extrusion stress (e.g., an extrusion stress applied inwardly) subjected by four corners is relatively greater, which easily generates a flexural fold, causes the pattern of touch sensor to be broken, and results in a poor touch performance.

FIG. 1B illustrates a pattern of a sensor 102 at a corner position of a touch substrate. The touch sensor 102 can include a first touch sensor 1021 and/or a second touch sensor 1022. The first touch sensor 1021 and the second touch sensor 1022 are insulated from each other. For example, the first touch sensor 1021 can be an inductive sensor (Rx) and the second touch sensor 1022 can be a driving sensor (Tx) without limited thereto. It's also possible that the first touch sensor 1021 is a driving sensor and the second touch sensor 1022 is an inductive sensor. Of course, it's not limited to the mode of driving sensor and inductive sensor. It can be any touch sensor as long as it achieves a detecting function of touch position.

FIG. 1B also illustrates a wiring 107, a first dummy line 1023 and a second dummy line 1024; the first dummy line 1023 and the second dummy line 1024 are insulated from each other. The arrangement of the first dummy line 1023 and the second dummy line 1024 can avoid signal interference and is beneficial for improving a touch effect. The first touch sensor 1021 and/or second touch sensor 1022 at other position(s) can be referred to the pattern(s) at the corner position(s). For example, the first touch sensor 1021 can be extending along a first direction, the second touch sensor 1022 can be extending along a second direction, and the first direction can be perpendicular to the second direction. For example, the first direction can be a horizontal direction, and the second direction can be a vertical direction. The touch sensor 102 can be disposed in a to-be-touched area.

FIG. 1C is an enlarged view illustrating a dashed box at position B in FIG. 1B, and FIG. 1C provides patterns of the first touch sensor 1021 and the second touch sensor 1022. For example, in FIG. 1C, a portion between the first touch sensor 1021 and the second dummy line 1024 (a portion between the two thin lines) is a portion 00102 which is hollowed out (removed) from a touch film layer; a portion between the first dummy line 1023 and the second dummy line 1024 (a portion between the two thin lines) is a portion which is hollowed out (removed) from the touch film layer; and a portion between the second touch sensor 1022 and the first dummy line 1023 (a portion between the two thin lines) is a portion which is hollowed out (removed) from the touch film layer. Other portions in FIG. 1C that have a same width with the removed portion 00102 each are a removed portion of the touch film layer, without particularly described one-by-one herein. FIG. 1C also illustrates a side edge 102001 of the touch sensor 102; a shape of the side edge 102001 of the touch sensor 102 can include a fold line shape, without limited thereto.

FIG. 1D illustrates a section view taken along CD direction in FIG. 1C. The first touch sensor 1021 is located on a base substrate 101, and can include a plurality of first mainbody parts 10211 and first connection parts 103 each located between adjacent first mainbody parts 10211; a space is provided between the first connection part 103 and the first mainbody part 10211; and the adjacent first mainbody parts 10211 can be electrically connected through the first connection part 103 and a first bridge part 105 which connects the first connection part 103 to the first mainbody part 10211. The first connection part 103 and the first mainbody part 10211 are provided with an insulating layer 108 thereon; the first bridge part 105 is electrically connected to the first connection part 103 and the first mainbody part 10211 through a via hole penetrating the insulating layer 108.

FIG. 1E illustrates a section view taken along EF direction in FIG. 1C. The second touch sensor 1022 is located on the base substrate 101, and can include a plurality of second mainbody parts 10221 and second connection parts 104 each located between adjacent two second mainbody parts 10221; a space is provided between the second connection part 104 and the second mainbody part 10221; and the adjacent second mainbody parts 10221 can be electrically connected through the second connection part 104 and a second bridge part which connects the second connection part 104 to the second mainbody part 10221. The second connection part 104 and the second mainbody part 10221 are provided with an insulating layer 108 thereon, and the second bridge part 106 is electrically to the second connection part 104 and the second mainbody part 10221 through a via hole penetrating the insulating layer 108.

For example, the first mainbody part 10211, the second mainbody part 10221, the first connection part 103 and the second connection part 104 can be located at a first layer, can be formed at a same layer, and can be formed from a same touch film layer by a patterning process. For example, they can be formed at a same layer, from a same touch film layer, by a same patterning process. For example, the touch film layer can be a transparent conductive film layer, and a material of the touch film layer can adopt a transparent conductive oxide material, without limited thereto. For example, the first connection part 103 and the second connection part 104 are provided with a space there-between so as to be insulated from each other. For example, the first connection part 103 has an annular shape, and the second connection part 104 is located in a hollow area inside the first connection part 103. The first connection part 103 and the second connection part 104 can adopt a transparent conductive oxide material, without limited thereto. For example, the first bridge part 105 and the second bridge part 106 can be located at a second layer.

For example, the first bridge part 105 and the second bridge part 106 can adopt a metallic material or a transparent conductive oxide material, without limited thereto. The transparent conductive oxide material includes, for example, indium tin oxide (ITO), without limited thereto.

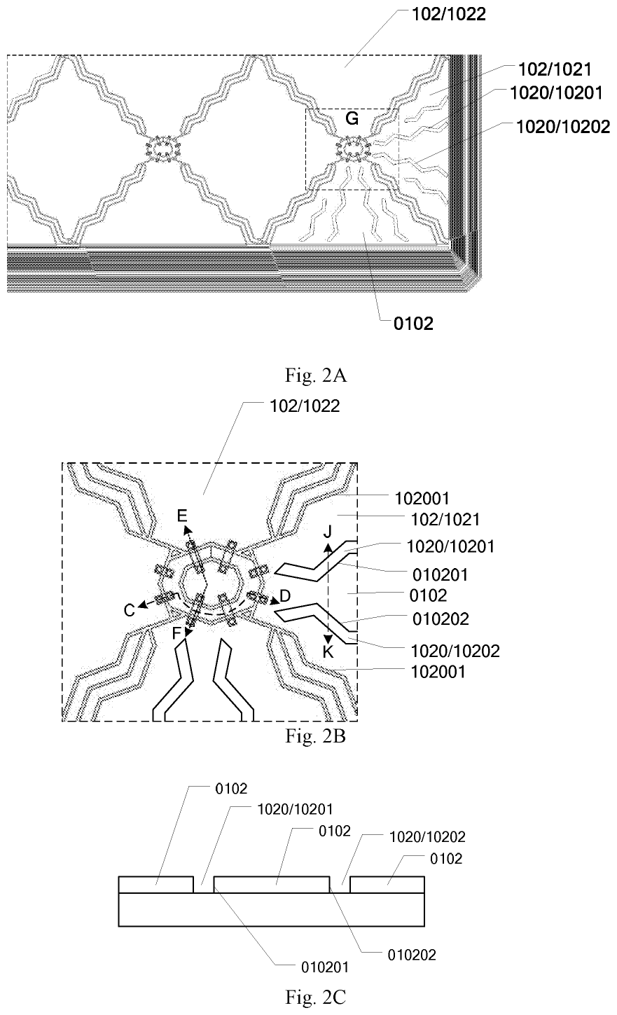

As illustrated in FIG. 2A, at least one embodiment of the present disclosure provides a touch substrate, including a base substrate 101 (reference may be made to FIG. 1D and FIG. 1E) and a touch sensor 102 disposed on the base substrate 101; at a position close to an edge of the base substrate 101, the touch sensor 102 includes a plurality of hollow parts 1020 arranged radially. For example, the plurality of hollow parts 1020 can be located in a fan-shaped area, without limited thereto; for example, it can be determined according to the shape of the touch sensor 102. The base substrate 101 can be a flexible base substrate, without limited thereto.

FIG. 2A merely illustrates a pattern of touch sensor 102 at a corner position, and other positions can be referred to FIG. 2A. For example, the base substrate 101 includes at least one corner, and the touch sensor 102 on at least one corner can be provided with a plurality of hollow parts 1020 arranged radially. For example, the plurality of hollow parts 1020 arranged radially can be disposed only at the corner position(s) of the base substrate 101, for example, on at least one corner, e.g., on four corners, without limited thereto. For example, the touch sensor 102 can be provided with a plurality of hollow parts 1020 arranged radially at a to-be-curved position or a curved position of the touch substrate, so as to eliminate or reduce the flexural fold in the pattern of touch sensor 102 caused by curving.

The touch sensor provided by at least one embodiment of the present disclosure can avoid poor touch performance resulted by a breakage of the pattern of touch sensor caused by the flexural fold generated from curving, by disposing a plurality of hollow parts 1020 arranged radially, so as to achieve improving the flexural fold resistive capability of the touch sensor 102, thereby improving the touch performance. For example, with the arrangement of the plurality of hollow parts 1020, it can provide a bearing space for the pattern of touch sensor 102 during curving, so that the flexural fold is not easy to be generated. Even if a flexural fold is generated, a damaged area on the pattern of touch sensor 102 still would be smaller than the case in which the plurality of hollow parts 1020 is not disposed. In this way, the influence to the touch performance is reduced. In addition to the above-mentioned touch sensor 102, the touch substrate can further include other touch sensor(s) which for example is/are not provided with the plurality of hollow parts 1020 arranged radially, without particularly limited in the embodiments of the present disclosure.

For example, as illustrated in FIG. 2A, a plurality of hollow parts 1020 arranged radially can improve a stealthy effect of the pattern of touch sensor 102, and can also improve a conductivity of the pattern of touch sensor 102. Compared to the case in which the plurality of hollow parts 1020 is not provided, it may not reduce the stealthy effect and the conductivity of the touch sensor.

As illustrated in FIG. 2A, according to the touch substrate provided by an embodiment of the present disclosure, in order to improve the stealthy effect, adjacent two hollow parts 1020 can be gradually converged in a direction from a position close to the edge of the base substrate 101 to a position far away from the edge of the base substrate 101.

FIG. 2A illustrates adjacent two hollow pars, i.e., a first hollow part 10201 and a second hollow part 10202 which are gradually converged in a direction from a position close to the edge of the base substrate 101 to a position far away from the edge of the base substrate 101. Adjacent two hollow pars gradually converging refers to that, for example, extending directions of the adjacent two hollow pars are gradually converged.

As illustrated in FIG. 2A, according to the touch substrate provided by an embodiment of the present disclosure, in order to improve the flexural fold resistive capability of the touch substrate at the edge and/or the corner position, at least one corner of the base substrate 101 is provided with a plurality of hollow parts 1020 arranged radially.

As illustrated in FIG. 2A, according to the touch substrate provided by an embodiment of the present disclosure, in order to benefit the manufacture and improve the stealthy effect, the hollow parts 1020 can have different shapes, without limited thereto.

As illustrated in FIG. 2A, according to the touch substrate provided by an embodiment of the present disclosure, the touch sensor 102 can be provided with no hollow part 1020 at other position(s) except the position close to the edge of the base substrate 101, without limited thereto.

As illustrated in FIG. 2A, according to the touch substrate provided by an embodiment of the present disclosure, the plurality of hollow parts 1020 provided in a same touch sensor 102 can have an axisymmetric structure, without limited thereto.

As illustrated in FIG. 2A, according to the touch substrate provided by an embodiment of the present disclosure, the corner position is provided with a first touch sensor 1021 and a second touch sensor 1022 which are intersected with each other and insulated from each other; a plurality of hollow parts 1020 in the first touch sensor 1021 and a plurality of hollow parts 1020 in the second touch sensor 1022 have an axisymmetric structure, without limited thereto.

As illustrated in FIGS. 2A and 2B, according to the touch substrate provided by an embodiment of the present disclosure, in order to improve the conductivity, a portion of the touch sensor 102 located between adjacent hollow parts 1020 is a sub-sensor part 0102; sub-sensor parts 0102 in a same touch sensor are electrically connected; two side edges of the sub-sensor part 0102 are gradually converged in a direction from a position close to the edge of the base substrate 101 to a position far away from the edge of the base substrate 101. As illustrated in FIG. 2B, two side edges 010201 and 010202 of the sub-sensor part 0102 are gradually converged. For example, two side edges of the sub-sensor part being gradually converged may refer to that, for example, extending directions of the two side edges of the sub-sensor part are gradually converged. For example, each of the side edges 010201 and 010202 of the sub-sensor part 0102 has a fold line shape.

As illustrated in FIG. 2B, according to the touch substrate provided by an embodiment of the present disclosure, in order to improve the stealthy effect, the shape of the hollow part 1020 is as same as the shape of the side edge 102001 of the touch sensor 102. For example, in FIG. 2B, both of the side edge of the touch sensor 102 and the hollow part 1020 have a fold line shape. For example, in addition to the fold line shape, each of the hollow parts 1020 can also have a curved line shape, a straight line shape or the like.

FIG. 2C illustrates a section view taken along JK direction in FIG. 2B. The section views taken along CD direction and EF direction in FIG. 2B are illustrated in FIG. 1D and FIG. 1E, respectively.

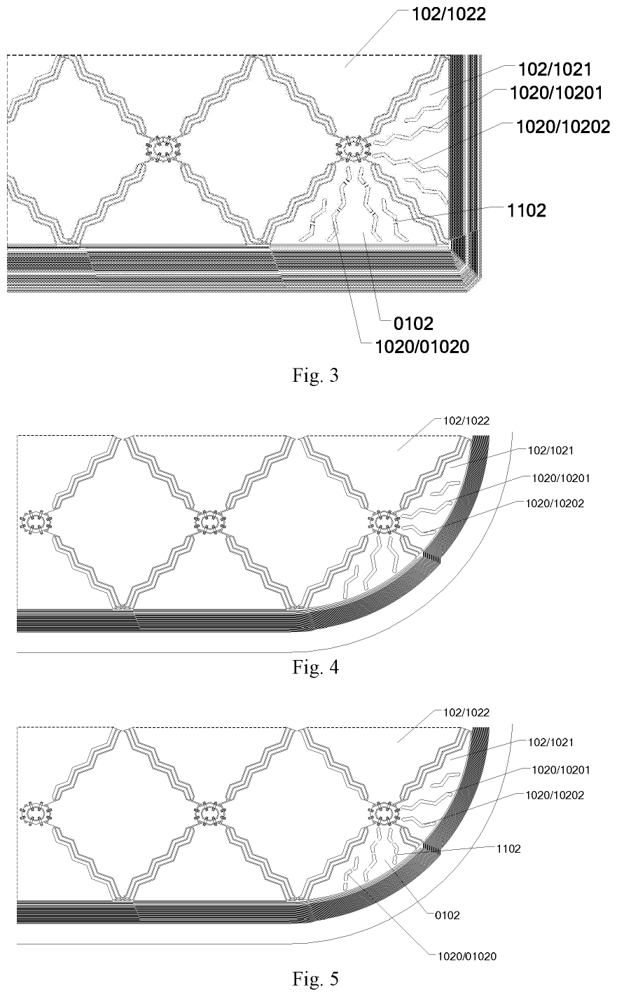

As illustrated in FIG. 3, according to the touch substrate provided by an embodiment of the present disclosure, in order to improve the conductivity of the touch sensor, each of the hollow parts 1020 can include a plurality of sub-hollow parts 01020; adjacent sub-hollow parts 01020 are provided with a connection part 1102 there-between; and adjacent sub-sensor parts 0102 are electrically connected through the connection part 1102. In this way, even if the pattern of touch sensor is partly hollowed or partly broken, it still would not influence the electrical connection of the pattern of touch sensor. For example, each of the hollow parts 1020 can include a plurality of sub-hollow parts 01020, the sub-hollow parts 01020 are spaced apart from each other and are extending along a same direction.

As illustrated in FIG. 4, according to the touch substrate provided by an embodiment of the present disclosure, the corner position of the touch substrate can also be a rounded corner, in addition to a straight corner or an approximate straight corner. At a position close to the edge of the base substrate 101, the touch sensor 102 includes a plurality of hollow parts 1020 arranged radially. At least one corner of the base substrate 101 can be provided with a plurality of hollow parts 1020 arranged radially, and the plurality of hollow parts 1020 arranged radially can be located at a to-be-curved position or a curved position on the touch substrate.

As illustrated in FIG. 5, according to the touch substrate provided by an embodiment of the present disclosure, in a touch substrate with a rounded corner, in order to improve the conductivity of the touch sensor 102, each of the hollow parts 1020 includes a plurality of sub-hollow parts 01020. Adjacent sub-hollow parts 01020 are provided with a connection part 1102 there-between, and adjacent sub-sensor parts 0102 are electrically connected through the connection part 1102. In this way, even if the pattern of touch sensor is partly hollowed or partly broken, it still would not influence the electrical connection of the pattern of touch sensor.

At least one embodiment of the present disclosure further provides a manufacturing method of a touch substrate, including forming a touch sensor 102 on a base substrate 101. At a position close to an edge of the base substrate 101, the touch sensor 102 includes a plurality of hollow parts 1020 arranged radially.

At least one embodiment of the present disclosure further provides a manufacturing method of a touch substrate. For example, part of area of the pattern of touch sensor can be etched away by an exposing process using a mask, so as to manufacture a plurality of hollow parts 1020 arranged radially. It can achieve improving the flexural fold resistive capability of the pattern of touch sensor without sacrificing the conductivity and the stealthy effect thereof, thereby improving the touch performance.

According to the manufacturing method of the touch substrate provided by an embodiment of the present disclosure, the mainbody part and the plurality of hollow parts 1020 of the touch sensor 102 can be formed by adopting a same material and by a same patterning process. For example, they can be formed from a same touch film layer; a pattern of the mainbody part of the touch sensor 102 is a reserved portion of the touch film layer, and the plurality of hollow parts 1020 is a removed portion (e.g., it can be removed by an etching process) of the touch film layer. In this way, it has no need of adding the amount of mask or the exposing process, which reduces the difficulty of technology without increasing the cost.

According to the manufacturing method of the touch substrate provided by an embodiment of the present disclosure, the touch sensor 102 and the plurality of hollow parts 1020 can be formed by adopting a same material and by a same patterning process. For example, they can be formed from a same touch film layer; a pattern of the touch sensor 102 is a reserved portion of the touch film layer, and the plurality of hollow parts 1020 is a removed portion (e.g., it can be removed by an etching process) of the touch film layer. In this way, it has no need of adding the amount of mask or the exposing process, which reduces the difficulty of technology without increasing the cost.

An embodiment of the present disclosure further provides a touch display device including the touch substrate provided by any of the embodiments of the present disclosure.

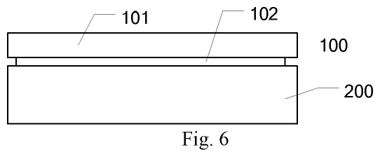

As illustrated in FIG. 6, according to a touch display device provided by an embodiment of the present disclosure, a touch substrate 100 can be disposed on a display panel 200, and a touch sensor 102 can be disposed at a side of the base substrate 101 close to the display panel 200, without limited thereto. For example, during curving, an edge can be curved downwardly to form an edge-curved touch display device.

In an embodiment of the present disclosure, the touch substrate can include a plurality of first touch sensors 1021 arranged along a first direction and a plurality of second touch sensors 1022 arranged along a second direction; the first direction can be perpendicular to the second direction; the plurality of first touch sensors 1021 and the plurality of second touch sensors 1022 are insulated from each other. Drawings accompanying the embodiments of the present disclosure only illustrate the pattern of touch sensor at the corner position of the touch substrate. In the embodiment of the present disclosure, description has been given with reference to the case in which the corner position is provided with a plurality of hollow parts arranged radially by way of example, but the position of the plurality of hollow parts is not limited thereto. For example, the plurality of hollow parts arranged radially can also be disposed at other position(s) of the touch substrate, for example, at left side, right side, upper side, lower side, central position or the like of the touch substrate. The sensor provided with the plurality of hollow parts 1020 arranged radially can be the first touch sensor 1021 and/or the second touch sensor 1022.

In the embodiment of the present disclosure, description has been given with reference to the touch sensor illustrated in FIG. 2A by way of example, but the embodiments are not limited thereto. The pattern(s) of the first touch sensor 1021 and/or the second touch sensor 1022 is/are not limited to that illustrated in FIG. 2A. For example, it's also possible that the first touch sensor 1021 is located at a first layer, the second touch sensor 1022 is located at a second layer, and the first touch sensor 1021 and the second touch sensor 1022 do not need to adopt a bridge structure. For example, it's also possible that one of the first touch sensor 1021 and the second touch sensor 1022 adopts a bridge structure, and the other one does not adopt the bridge structure.

Herein, it should be understood that, in the embodiments of the present disclosure, “a same layer” refers to a layer structure which is obtained by forming a film layer configured to form a certain pattern by using a same film formation process and then patterning the film layer by a single patterning process using a same mask. A single patterning process can include multiple times of exposing processes, developing processes or etching processes according to different certain patterns; moreover, the certain patterns in the layer structure as formed can be continuous and can also be discontinuous, and these certain patterns can also be located at different heights or have different thicknesses.

In the embodiments of the present disclosure, patterning or patterning process can only include a photolithography process, or can include the photolithography process and etching step(s), or can include printing, ink-jetting and other processes for forming a predetermined pattern. The photolithography process refers to a process of forming a pattern by using photoresist, mask and exposure machine, including craft processes such as film forming, exposing, developing or the like. Corresponding patterning process can be selected according to the structure as formed in the embodiments of the present disclosure.

The following statements should be noted:

(1) unless otherwise defined, in embodiment(s) and accompanying drawings of the present disclosure, the same reference sign indicates the same meaning,

(2) The drawings accompanying the embodiment(s) of the present disclosure involve only the structure(s) in connection with the embodiment(s) of the present disclosure, and other structure(s) can be referred to common design(s).

(3) For the purpose of clarity only, in accompanying drawings for illustrating the embodiment(s) of the present disclosure, the thickness of a layer or an area may be enlarged. It should understood that, in the case in which a component such as a layer, film, area, substrate or the like is referred to be “on” or “under” another component, it may be directly on or under the another component, or a component may be interposed there-between.

(4) In case of no conflict, features in one embodiment or in different embodiments of the present disclosure can be combined with each other.

The above are merely specific implementations of the present disclosure without limiting the protection scope of the present disclosure thereto. Within the technical scope revealed in the present disclosure, modification(s) or substitution(s) may be easily conceivable for those skilled who are familiar with the present technical field, and these modification(s) and substitution(s) all should be contained in the protection scope of the present disclosure. Therefore the protection scope of the present disclosure should be based on the protection scope of the appended claims.

1. A touch substrate, comprising a base substrate and a touch sensor on the base substrate,
the touch sensor comprising a plurality of hollow parts arranged radially.

2. The touch substrate according to claim 1, wherein the plurality of hollow parts arranged radially is located at a position close to an edge of the base substrate.

3. The touch substrate according to claim 1, wherein the base substrate comprises at least one corner, and the at least one corner is provided with the plurality of hollow parts arranged radially.

4. The touch substrate according to claim 1, wherein in a direction from a position close to an edge of the base substrate to a position far away from the edge of the base substrate, adjacent two of the plurality of hollow parts are gradually converged.

5. The touch substrate according to claim 1, wherein each of the plurality of hollow parts has a shape the same as a shape of a side edge of the touch sensor.

6. The touch substrate according to claim 5, wherein the shape of the side edge of the touch sensor comprises a fold line shape.

7. The touch substrate according to claim 1, wherein the hollow parts have a same shape.

8. The touch substrate according to claim 1, wherein each of the hollow parts comprises at least one of a fold line shape, a curved line shape and a straight line shape.

9. The touch substrate according to claim 1, wherein a portion of the touch sensor located between adjacent ones of the plurality of hollow parts is a sub-sensor part,
sub-sensor parts are electrically connected with each other, and
in a direction from a position close to an edge of the base substrate to a position far away from the edge of the base substrate, two side edges of the sub-sensor part are gradually converged.

10. The touch substrate according to claim 9, wherein each of the plurality of hollow parts comprises a plurality of sub-hollow parts,
a connection part is provided between adjacent ones of the plurality of sub-hollow parts, and
adjacent ones of the plurality of sub-sensor parts are electrically connected through the connection part.

11. The touch substrate according to claim 9, wherein the plurality of sub-hollow parts are spaced apart from each other and are extending in a same direction.

12. The touch substrate according to claim 1, wherein the touch sensor and the plurality of hollow parts are formed from a same touch film layer,
the touch sensor is a reserved portion of the touch film layer, and
the plurality of hollow parts is a removed portion of the touch film layer.

13. The touch substrate according to claim 1, wherein the plurality of hollow parts arranged radially has an axisymmetric structure.

14. The touch substrate according to claim 1, wherein the touch sensor comprises a first touch sensor and a second touch sensor,
a plurality of hollow parts arranged radially in the first touch sensor and a plurality of hollow parts arranged radially in the second touch sensor have an axisymmetric structure.

15. A manufacturing method of a touch substrate, comprising:
forming a touch sensor on a base substrate, the touch sensor comprising a plurality of hollow parts arranged radially.

16. The manufacturing method of the touch substrate according to claim 15, wherein the plurality of hollow parts arranged radially is located at a position close to an edge of the base substrate.

17. The manufacturing method of the touch substrate according to claim 15, wherein the touch sensor and the plurality of hollow parts are formed from a same touch film layer by a same patterning process,
the touch sensor is a reserved portion of the touch film layer, and
the plurality of hollow parts is a removed portion of the touch film layer.

18. A touch display device, comprising the touch substrate according to claim 1.
